(19) United States
(12) Patent Application Publication
(10) Pub. No.: US 2010/0219628 A1
(43) Pub. Date: Sep. 2, 2010

(54) Pipe and Siphon Receptacle Apparatus Coupling Adaptor

(76) Inventor: Eric Gray, Pahrump, NV (US)

Correspondence Address: QUARLES & BRADY LLP, ONE SOUTH CHURCH AVENUE, SUITE 1700, TUCSON, AZ, 85701-1621, US

(21) Appl. No.: 12/778,003

(22) Filed: May 11, 2010

Related U.S. Application Data
(63) Continuation-in-part of application No. 11/566,451, filed on Dec. 4, 2006, now Pat. No. 7,717,474.

(51) Int. Cl. F16L 43/00

(52) U.S. Cl. 285/134.1

(57) ABSTRACT

An adaptor for coupling pipes together that has a pair of spaced apart pipe members disposed parallel to each other, with each of pair of pipe members including an opening at a top and at a bottom for receiving an additional pipe, and a bridging member connecting the pair of pipe members and defining a passage between the pipe members. A kit including an adaptor and one or more additional pipe members also is provided.

### CROSS REFERENCE TO RELATED APPLICATION

This application is a continuation-in-part of, and claims priority to, U.S. patent application Ser. No. 11/566,451, filed on Dec. 4, 2006.

### BACKGROUND OF THE INVENTION

1. Field of the Invention

The invention relates to a adaptor that is especially useful for coupling common plumbing components together. In one embodiment, the adaptor may be used to create an overflow siphon apparatus by inserting common PVC pipe (capped off, forming a well) into the new adaptor.

2. Description of the Related Art

A variety of devices are known to exist for coupling pipes together, ranging from standard fittings to adhesives. A fitting must provide good connectability, and, depending on the application, access to other pipe components and adequate pressure resistance. Thus, for example, a siphon or overflow box of the type commonly used for aquariums ideally would be made from pipes and fitting that are economical to make, easy to assemble, simple to disassemble for cleaning, and adequately well connected to resist any leaks resulting from the large volume of water constantly moving through these apparatus. However, most siphons or overflow boxes today are made from injection molded or assembled pieces of flat material that are relatively expensive to manufacture and require the skills of an experienced artisan.

U.S. Pat. No. 4,761,227 issued to Willinger et al. discloses a “overflow box-type” aquarium filter that includes an intake chamber for receiving contaminated aquarium water from the aquarium tank and a filter chamber in flow communication with the intake chamber. An impeller serves to draw water from the aquarium tank to the intake chamber through a removable intake U-tube. Upon stoppage of the impeller, the flow of water reverses and flows back into the aquarium tank. While this device may be suitable for its particular purpose, it is unnecessarily complicated and requires that the impeller stops before too much water is drawn into the filter chamber such that overflow occurs.

U.S. Pat. No. 5,728,293 by Guoli et al. discloses a filter assembly that has a generally U-shaped siphon tube that has telescopic legs and a flow regulator that provide for flow between the filter assembly and the aquarium tank. While the U-shaped siphon tube is removable from both the filter area and tank for cleaning, the flow regulator and removable legs make this siphon relatively complex to manufacture and increase the risk that a part of the siphon will be lost or broken from disassembly and handling.

Hence, it would be useful to have a pipe fitting that enables a common person with limited skills to conveniently assemble a siphon receptacle from common parts, thus providing an economical and easy to create apparatus.

### SUMMARY OF THE INVENTION

The invention relates in general to an adaptor for coupling pipes together. More particularly, the adapter includes a pair of spaced apart pipe members disposed parallel to each other, with each pipe member including an opening at its top, i.e., first end, and bottom, i.e., second end, that is adapted to receive an additional pipe. A bridging member connects the pair of pipe members and defines a passage between the pipe members.

In one embodiment of the invention, the siphon receptacle apparatus coupling adaptor comprises a U-shaped member. The U-shaped member may be substantially flat along a top edge, thereby allowing a second U-shaped pipe (such as a siphon tube) to be nested inside the top openings in a manner that provides for fluid flow through the second U-shaped member if submerged in capped off pipes inserted into the receptacle apparatus coupling adapter forming a fluid well.

In another embodiment, the pair of spaced apart pipe members comprise an H-shaped member.

In still another embodiment of the invention, the adapter includes a pair of spaced apart pipe members disposed parallel to each other, with each pipe member including an opening at its top and bottom that is adapted to receive an additional pipe, and a bridging member that connects the pair of pipe members at a bridge member and defines an open concave passage between the pipe members.

In yet another embodiment of the invention, a kit for coupling pipes together is provided. The kit includes (1) an adaptor having a pair of spaced apart pipe members disposed parallel to each other, with each of the pair of pipe members including an opening at the top, i.e., first end, and bottom, i.e., second end, to receive an additional pipe, and a bridging member connecting the pipe members and defining a passage between them; and (2) at least one additional pipe member adapted for placement within an opening of the pair of pipe members. Preferably, the additional pipe member is adapted for placement within the opening of the pair of pipe members through frictional engagement, such as through a “taper fit” commonly employed in PVC pipe fittings. However, the use of adhesives or male/female threads also may be desired depending on the application.

Additional features and advantages of the invention will be forthcoming from the following detailed description of certain specific embodiments when read in conjunction with the accompanying drawings. For example, the kit of the invention may further include a plurality of additional pipe members that comprise the components of an apparatus, such as an overflow siphon box or siphon receptacle apparatus. Hence, the invention is scalable to cover a wide range of application and flow requirements.

### BRIEF DESCRIPTION OF THE DRAWINGS

FIG. 1 is side elevational view of a first embodiment of the invention.

FIG. 2 is a top plan view of the embodiment illustrated in FIG. 1.

FIG. 3 is a cross-sectional view taken along line 3-3 of the embodiment in illustrated in FIG. 2.

FIG. 4 is a side elevational view of a second embodiment of the invention.

FIG. 5 is a partially assembled side view of a kit embodiment of the invention.

FIG. 6 is a partial view of FIG. 5 and shows the structural arrangement that occurs when member 52 contacts the passage area of the bridging member.

FIG. 7 is a perspective view of a third embodiment of the invention.

FIG. 8 is a top plan view of the embodiment shown in FIG. 7.

FIG. 8A is a cross-sectional view taken along line 8A-8A of the embodiment in illustrated in FIG. 8.

### DESCRIPTION OF THE PREFERRED EMBODIMENTS

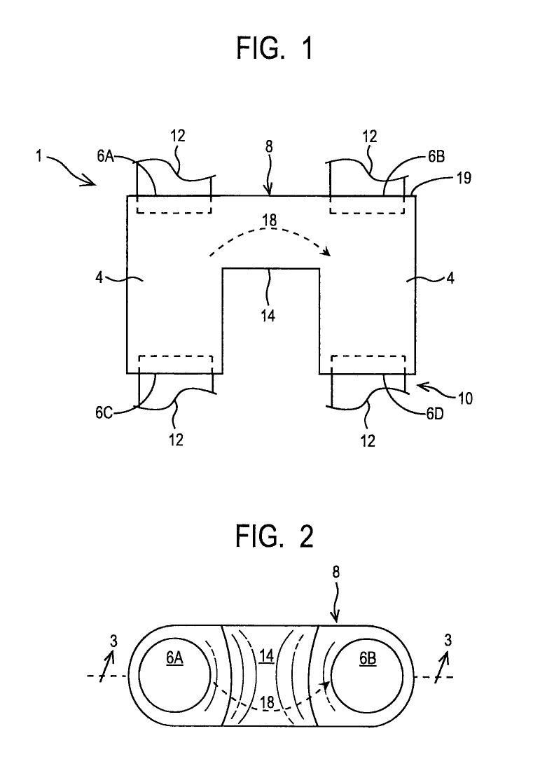

Referring to FIG. 1, the numeral 1 refers to a U-shaped adaptor for coupling pipes together. The adaptor includes a pair of spaced apart pipe members 4 disposed parallel to each other, wherein each of the pair of pipe members 4 includes an opening 6A-6D at a top 8 and at a bottom 10 of the pipe members. As shown, each opening 6A-6D is adapted to receive an additional pipe 12.

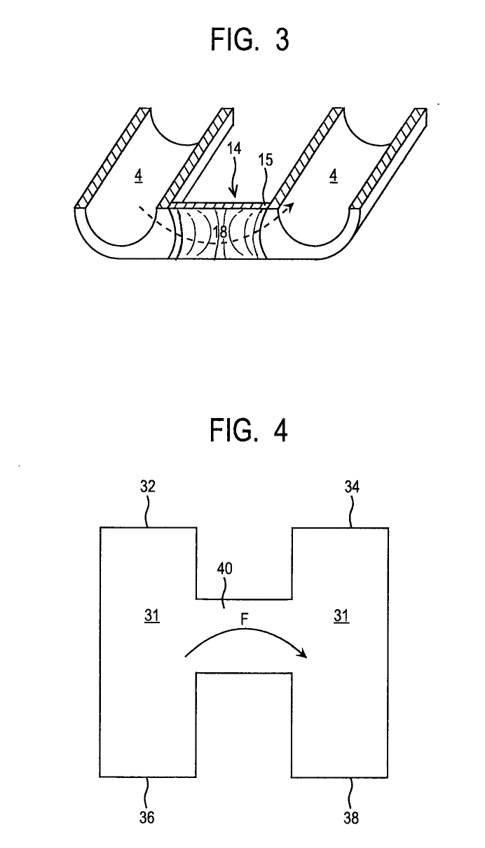

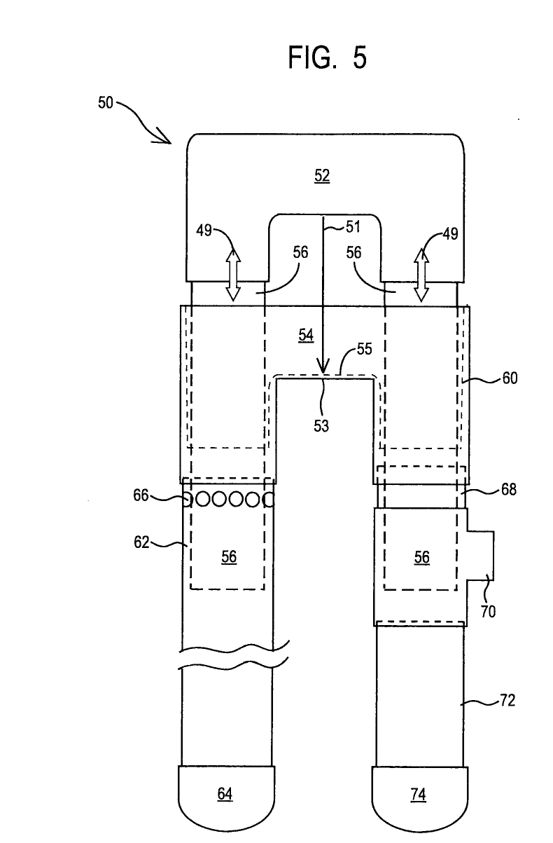

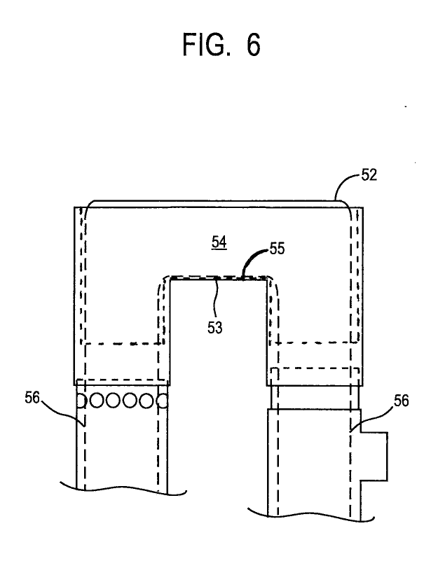

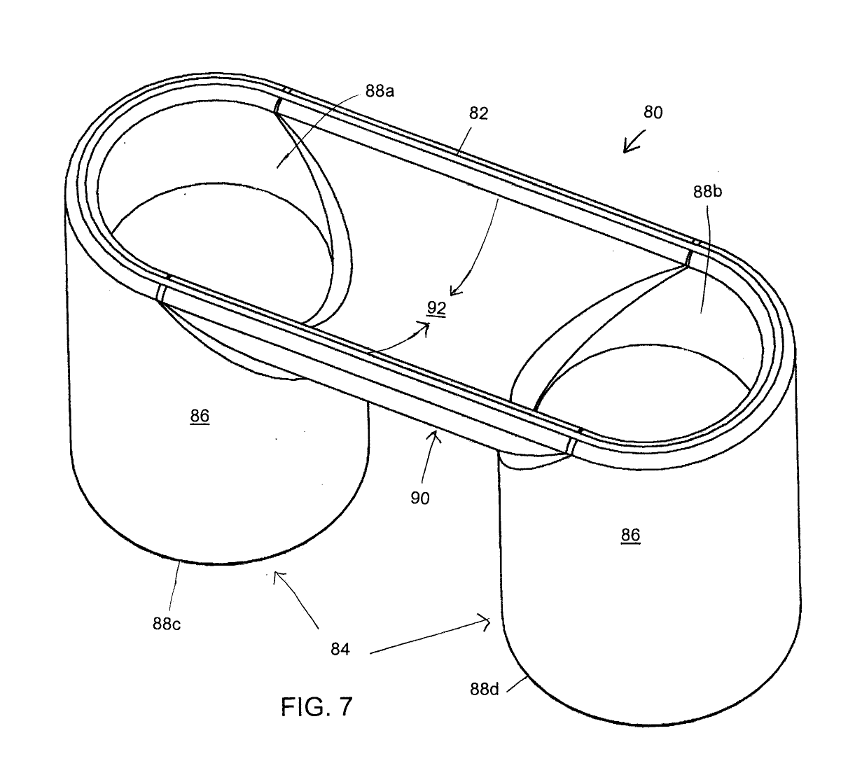

The pair of pipe members 4 are spaced apart by a bridging member 14 that defines a passage 18 between pipe members 4 (the passage 18 being more clearly shown in FIGS. 3 and 4). The purpose of the passage 18 is to provide for fluid flow between pipe members and/or to provide a concave channel for nesting addition pipe structures within the adaptor. Indeed, depending on the additional pipe structure(s), no fluid may flow through the channel 18 (see, for example, FIG. 5). Moreover, the adaptor 1 may be substantially flat along a top edge 19 to best interface or nest with additional structures, such as pipe members 12.

Turning to FIG. 2, a top view of the embodiment shown in FIG. 1 is shown. The cross-sectional view of FIG. 3 reveals the bridging member 14 of this embodiment includes both a solid portion 15 and a generally concave passage 18 that is open (i.e., not covered) and through which fluid (indicated by arrows) may flow.

A second embodiment of the invention is illustrated in FIG. 4. As shown, the adaptor comprises a generally H-shaped member 30 that includes a pair of pipes 31 having openings 32, 34, 36 and 38 disposed in parallel and connected by a bridging member 40. As indicated, bridging member 40 may be a open passage that allows fluid F to flow between the pipes 31.

Turning to the embodiment shown in FIG. 5, a kit for coupling pipes together is disclosed. The kit 50 includes an adaptor 54 that is adapted to receive at least one additional pipe member, such as U-shaped member 52 having legs 56. U-shaped member 52 may be frictionally engaged within adaptor 54 through tapered walls 60, thus creating a seal within adaptor 54. Moreover, due to the frictional engagement, U-shaped member 52 also may be removed from adaptor 54 (as indicated by arrows 49). Alternatively, an adhesive, such as PVC cement, may be used to join the each kit component as desired. In this embodiment, when the U-shaped member 52 is nested within adaptor 54 (as depicted by arrow 51), the U-shaped member contacts bridging member 53 along the open concave passage 55.

Additional components may be included in the kit 50. Thus, coupled to the bottom of adaptor 54 is pipe 62, having end cap 64 and opening 66, and pipe 68, which includes T-junction 70, pipe 72 and end cap 74. All of these components, including adaptor 54, may be economically produced and sold as a kit for assembly into an overflow siphon apparatus useful for exchanging water between an aquarium tank and filter. Thus, the adaptor of the invention facilitates the coupling of kit components in a simple and low-cost manner.

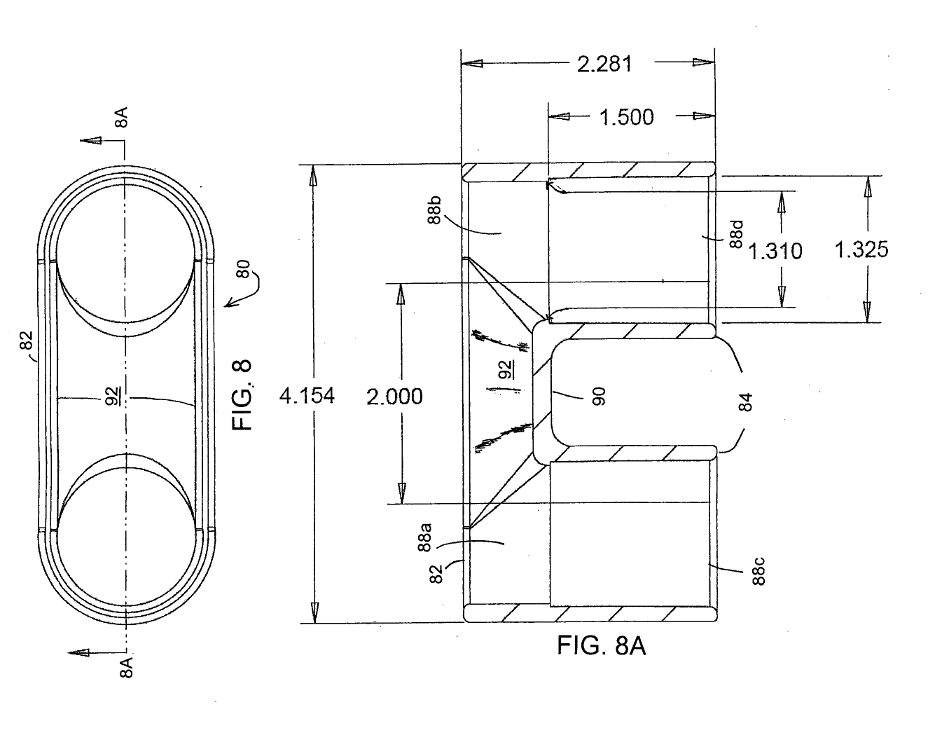

Turning to the embodiment shown in FIGS. 7, 8 and 8A, a third embodiment of an adaptor of the invention is disclosed. The adaptor 80 has an open first end 82 and a second end 84 and further includes a pair of spaced apart pipe members 86 adapted for fluid flow therethrough and disposed parallel to each other, wherein the pair of pipe members 86 include a first pair of openings (88a, 88b) at the adaptor open first end 82 and a second pair of openings (88c, 88d) at the adaptor second end 84. Each of the first and second pair of openings (88a, 88b, 88c, 88d) are adapted to receive an additional pipe, and a bridging member 90 connects the pair of spaced apart pipe members 86 and defines inside and proximal to the open first end 82 of the adaptor 80 a concave passage 92 between the pair of spaced apart pipe members 86.

Furthermore, the first pair of openings (88a, 88b) at the open first end 82 are formed such that a pair of pipe members are receivable in concentric arrangement with a second pair of additional pipe members joined with the second pair of openings (88c, 88d) at the adaptor second end 84 (such as shown in FIG. 5, wherein legs 56 of U-shaped member 52 are concentrically disposed inside pipes 62 and 68).

The adaptor itself preferably is formed to receive pipe members at each end in concentric arrangement as illustrated in FIG. 5 by having the first pair of openings (88a, 88b) at the open first end 82 be of a smaller diameter than the second pair of openings (88c, 88d) at the second end 84 (FIG. 8A).

Various modifications are possible within the meaning and range of equivalence of the appended claims.

I claim:

1. A single-piece pipe adaptor having an open first end and a second end, the pipe adaptor comprising:
(a) a pair of spaced apart pipe members adapted for fluid flow therethrough and disposed parallel to each other, wherein said pair of pipe members includes a first pair of openings at the adaptor open first end and a second pair of openings at the adaptor second end, with each of said first and second pair of openings being adapted to receive an additional pipe, and
(b) a bridging member that connects the pair of spaced apart pipe members and defines inside and proximal to the open first end of said adaptor a concave passage between said pair of spaced apart pipe members,
wherein the first pair of openings at the open first end of said adaptor have a smaller diameter than the second pair of openings at the second end.

2. The adaptor of claim 1, wherein said open first end is substantially flat along a top edge.

3. A single-piece pipe adaptor having an open first end and a second end, the pipe adaptor comprising:
(a) a pair of spaced apart pipe members adapted for fluid flow therethrough and disposed parallel to each other, wherein said pair of pipe members includes a first pair of openings at the adaptor open first end and a second pair of openings at the adaptor second end, each of said first and second pair of openings being adapted to receive an additional pipe, and
(b) a bridging member that connects the pair of spaced apart pipe members and defines inside and proximal to the open first end of said adaptor a concave passage between said pair of spaced apart pipe members,
wherein the first pair of openings at the open first end of said adaptor are sized such that a first pair of said additional pipe are receivable in concentric arrangement with a second pair of additional pipe joined with said second pair of openings at the adaptor second end.
